(19) United States
(12) Patent Application Publication
(10) Pub. No.: US 2016/0183043 A1
(43) Pub. Date: Jun. 23, 2016

(54) System And Method For Distributed And Dynamic Location Identification Of Mobile Devices

(71) Applicant: Jordan University of Science and Technology, Irbid (JO)

(72) Inventor: Fahed Hasan Awad, Irbid (JO)

(21) Appl. No.: 14/581,242

(22) Filed: Dec. 23, 2014

(51) Int. Cl. H04W 4/02; H04W 24/02; H04W 40/24

(52) U.S. Cl. CPC H04W 4/02; H04W 40/244; H04W 24/02

(57) ABSTRACT

The present invention provides a system and method for distributed and dynamic location identification of mobile devices, wherein such method continuously estimates the path loss exponent for a specific environment from a priori known distance, hence estimating the distance to another transmitter. In the system and method of the present invention, any blind node can estimate its own location if there exists at least three nodes connected via wireless links in a distributed ad hoc mode within a radio communication range of each other and if each one of said nodes is either equipped with location identification mechanism or its location is fixed and known priori.

### FIELD OF THE INVENTION

The present invention relates to a system and method for distributed and dynamic location identification of mobile devices, and more particularly by continuously estimating the path loss exponent of the environment using the lognormal shadowing with exponential path loss model for wireless signal propagation.

### BACKGROUND OF THE INVENTION

Location identification of mobile devices has become an important issue recently, for which many technologies were developed.Low-cost, low-complexity devices for partially obstructed environments and efficient location identification strategies have become a necessity.For this reason, numerous patent applications have disclosed systems and methods for location identification of mobile devices.

Among saidconventional solutions, a method of identifying a location of a node i in a network having a plurality of nodes, wherein determining of the location of node i is identified by intersecting regions that are guaranteed to contain the node i with respect to the other nodes that are neighbors of node i and iteratively minimizing the size of intersection region containing node i.

Another conventional solution, a system and method for computing the location of a mobile terminal in a wireless communications network, such as an ad-hoc wireless communications network. In particular, the system and method estimates the location of a mobile terminal in a wireless communications network, such as an ad-hoc terrestrial wireless communications network, based on estimated distances to a plurality of terrestrial reference terminals using error minimizing techniques, such as those based on Gauss's postulate. In doing so, the system and method estimate a respective distance from the mobile terminal from the reference terminals, calculate a respective simulated pattern, such as a sphere or circle, about each of the respective reference terminals based on the respective distance from the terminal to each respective reference terminal and the respective locations of the respective reference terminals, estimates a location at which each of the simulated patterns intersect each other, and identifies the estimated location as representing the location of the terminal.

Another conventional solution, a system and method for providing a network of wireless devices including Mobile Terminals, Wireless Routers and a Local Control within a high rise building or other three dimensional deployment structure, such that communication, identification and position calculations can be achieved regardless of environment nature. Mobile Terminals are deployed to assume any random positions within a three dimensional deployment structure. Communication and position calculations are provided at each level, or floor of the building, by Horizontal and Vertical Routers, where Vertical Routers are further used to successfully communicate between levels, or floors. The Vertical Routers provide communication links with the Local Controller via one or more Intelligent Access Points.; the infrastructure of Vertical and Horizontal routers, the Intelligent Access Points and the Local Control are elements of an infrastructure deployed before a fire incident or other emergency happens. In emergency situations the infrastructure emerges with ad-hoc deployed elements creating a system that assures stable communication, identification and accurate computation of location for all participants to emergency action.

None of the above conventional solutions disclosed a system and method fordistributed and dynamic location identification of mobile devices, and more particularly by continuously estimating the path loss exponent of the environment using the lognormal shadowing with exponential path loss model for wireless signal propagation.

### SUMMARY OF THE INVENTION

It is therefore an object of the preset invention to provide a system and method for distributed and dynamic location identification of mobile devices.

It is an aspect of the present invention to have asystem and method for distributed and dynamic location identification of mobile devices, and more particularly by continuously estimating the path loss exponent of the environment using the lognormal shadowing with exponential path loss model for wireless signal propagation.

It is an aspect of the present invention to estimate the path loss exponent for a specific environment from a priori known distance, hence estimating the distance to another transmitter.

It is an aspect of the present invention to dynamically and continuously estimating the path loss exponent of the surrounding environment using the received signal strength indicator (RSSI) of the wireless communication signal combined with the location information of the reference node.

In the method of the present invention, any blind node can estimate its own location if there exists at least three nodes connected via wireless links in a distributed ad hoc mode within a radio communication range of each other and if each one of said nodes is either equipped with location identification mechanism or its location is fixed and known priori.

In another aspect of the present invention, each reference node periodically transmits its current location information along with the transmit power used and the current estimation of the path loss exponent.

In another aspect of the present invention, each said reference node transmits a reference beacon that contains its current location, the transmit power level used and its estimated path loss exponent.

It is an aspect of the present invention to have a plurality of samples at different distances from the transmitter to get a good estimation of the path loss exponent. Said plurality of samples is then averaged so that the mean Gaussian random variable converges to zero.

In another aspect of the present invention, said blind node calculates the estimated distance from its current location to the current location of said reference node for each reference beacon.

In the method of the present invention having obtained said reference beacon from three different reference nodes, said blind node uses the location information received from said reference nodes along with the estimated distances to each reference node to estimate the location of said blind node.

### BRIEF DESCRIPTION OF THE DRAWINGS

The invention will now be described with reference to the accompanying drawings, which illustrate a preferred embodiment of the present invention without restricting the scope of the invention's concept, and in which:

FIG. 1 illustrates a schematic diagram of a system for distributed and dynamic location identification of mobile devices configured according to a preferred embodiment of the present invention.

### DETAILED DESCRIPTION OF THE PREFERRED EMBODIMENT

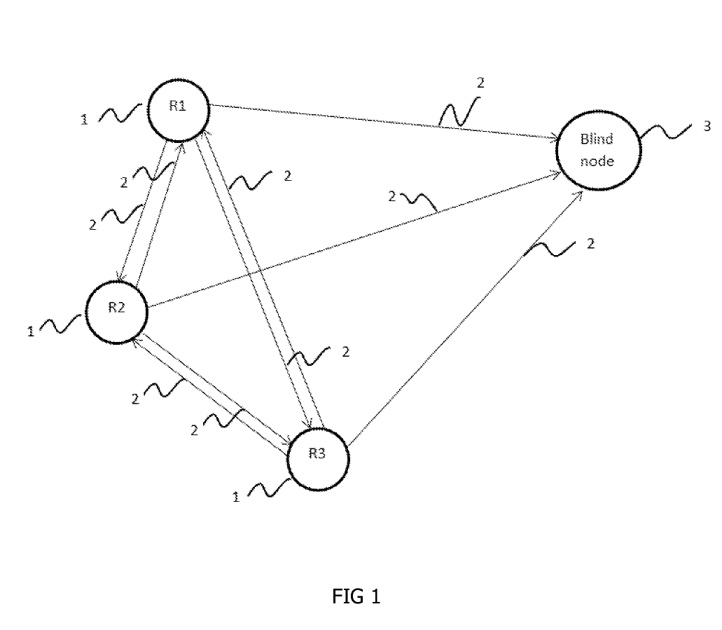

FIG. 1 illustrates a method and a system for distributed and dynamic location identification of mobile devices configured according to a preferred embodiment of the present invention. Such system comprises at least three reference nodes (1) and a blind node (3), wherein the location of such blind node (3) can be estimated using the pre-determined locations of said reference nodes (1).

In the preferred embodiment of the present invention, said reference nodes (1) can transmit and receive reference beacons (2).

In the preferred embodiment of the present invention, said reference nodes (1) are connected via wireless links in a distributed ad hoc mode within a radio communication range of each other.

In the preferred embodiment of the present invention, said method comprises the following steps:
a—Calculating the distance between the transmitting and receiving reference nodes(1);
b—Calculating an estimated path loss exponent using said calculated distance and the received signal strength indicator associated with said reference beacon (2);
c—Using all reference beacons (2) received to estimate the average path loss exponent;
d—Calculating the distance from the current location of said blind node to the current location of said reference node (1) for each reference beacon (2);
e—Estimating the current location of said blind node using the location information received from said reference nodes (1) along with said calculated distances;

The method in the preferred embodiment of the present invention uses the lognormal shadowing with exponential path loss model for wireless signal propagation.

In the preferred embodiment of the present invention, the path loss exponent is dynamically and continuously estimated for the surrounding environment using the received signal strength indicator of the wireless communication signal combined with location information of said reference node (1).

In the preferred embodiment of the present invention each of said reference nodes (1) is either equipped with location identification mechanism or its location is fixed and known priori.

In the preferred embodiment of the present invention each of said reference nodes (1) periodically transmits said reference beacon (2) that contains the current location information of such reference node (1) along with the transmit power used and the current estimation of the path loss exponent.

In the preferred embodiment of the present invention, any blind node within the radio communication range of at least three reference nodes (1) will be able to hear the reference beacons (2) and make use of the corresponding information included, along with the associated received signal strength indicator to estimate its own location.

In the preferred embodiment of the present invention a plurality of reference beacons (2) is needed so that the average path loss exponent converges to the actual path loss exponent associated with the environment surrounding the reference nodes (1), hence having better location estimation for said blind nodes (3).

In the preferred embodiment of the present invention said reference nodes and said blind nodes can be static or dynamic.

The method in the preferred embodiment of the present invention can be used for both indoor and outdoor environments because it can be configured according to the corresponding environment.

In the preferred embodiment of the present invention such environment can be quasi-static, dynamic and very dynamic.

The invention will be further described and illustrated for the preferred embodiment of this invention, which is a system and method for distributed and dynamic location identification of mobile devices, in the following example.

### EXAMPLES

The following example illustrates the present invention without however, limiting the same thereto.

### Example 1

### Worst Case Performance

In the preferred embodiment of the present invention a simple test scenario of three reference nodes (1) and one blind node (3) was simulated under a number of practical circumstances, wherein such scenario have a blind node 3 located at coordinates (25,25) and three reference nodes (1) located at coordinates (30,0), (5,50) and (50,35) respectively. The actual path loss exponent is 3, the transmit power is of 18 dBm and the standard deviation of the random variable representing the variation in the path loss was tested for 2 dB, 4 dB and 6 dB representing quasi-static, dynamic and very dynamic environments respectively. The simulation was run for 500 trials. That is, each of said reference nodes (1) should receive a total of 500 reference beacons; 250 reference beaconsfrom each of other two reference nodes. When using the worst case estimation of N=1 to estimate said path loss exponent at each said reference node (1), the test showed that all nodeschange randomly according to the signal variation with no converging. For 2 dB signal variation most of the distance estimations fall within about 5 meters of the actual position with an average of 2.6 meters. This indicates that even with no averaging, the location approximation is still fair. However for 4 dBm and 6 dBm variations, the error exceeds 5 and 10 meters respectively.

### Example 2

### Practical Case Performance

In the preferred embodiment of the present invention a simple test scenario of three reference nodes (1) and one blind node (3) was simulated under a number of practical circumstances, wherein such scenario have a blind node 3 located at coordinates (25,25) and three reference nodes (1) located at coordinates (30,0), (5,50) and (50,35) respectively. The actual path loss exponent is 3, the transmit power is of 18 dBm and the standard deviation of the random variable representing the variation in the path loss was tested for 2 dB, 4 dB and 6 dB representing quasi-static, dynamic and very dynamic environments respectively. The simulation was run for 500 trials. That is, each of said reference nodes (1) should receive a total of 500 reference nodes; 250 reference nodes from each of other two reference nodes. In this example the reference node (1) estimates said path loss exponent by calculating the mean of the last ten received reference nodes. This value of such node allows the up and down signal variations to cancel each other out, hence smoothing out the sharp variation in the estimation process. In addition, in dynamic environments, it eliminates the impact of very old samples that no longer represents the current conditions of the environment. In this case, said path loss exponent converges to the actual path loss exponent after 100,200 and 400 trials for 2 dBm, 4 dBm and 6 dBm signal variations respectively, and most of the errors are around or below 2 meters, which concludes that the estimated locations are concentrated within very close proximity of the target locations.

In the preferred embodiment of the present invention, while the present invention has been described with reference to a specific embodiment thereof, it is apparent that additions, omissions and modifications can be made by a one skilled in the art without departing from the scope and spirit thereof.

1. A system for distributed and dynamic location identification of mobile devices comprising a plurality of blind nodes and at least three reference nodes transmitting and receiving a plurality of reference beacons.

2. The system of claim 1, wherein the location of such blind node can be estimated using the pre-determined locations of said reference nodes.

3. The system of claim 1, wherein said reference nodes are connected via wireless links in a distributed ad hoc mode within a radio communication range of each other.

4. A method for distributed and dynamic location identification of mobile devices comprising the steps of:
Calculating the distance between the transmitting and receiving reference nodes;
Calculating an estimated path loss exponent using said calculated distance and the received signal strength indicator associated with said reference beacon;
Using all reference beacons received to estimate the average path loss exponent;
Calculating the distance from the current location of said blind node to the current location of said reference node for each reference beacon; and
Estimating the current location of said blind node using the location information received from said reference nodes along with said calculated distances.

5. The method of claim 4, wherein said path loss exponent is dynamically and continuously estimated for the surrounding environment.

6. The method of claim 4, wherein said reference nodes periodically transmit said reference beacon that contains the current location information of said reference node along with the transmit power used and the current estimation of said path loss exponent.

7. The method of claim 4, wherein said reference nodes and said blind nodes can be static or dynamic.

8. The method of claim 4, wherein a plurality of reference beacons is needed so that the average path loss exponent converges to the actual path loss exponent associated with the environment surrounding the reference nodes, hence having better location estimation for said blind nodes.

9. The method of claim 4, wherein said environment can be quasi-static, dynamic and very dynamic.

10. The method of claim 4, wherein said method can be used for both indoor and outdoor environments.

11. The method of claim 8, wherein said environment can be quasi-static, dynamic and very dynamic.
